(19) United States
(12) Patent Application Publication
(10) Pub. No.: US 2025/0256809 A1
(43) Pub. Date: Aug. 14, 2025

(54) STRADDLE VEHICLE CHASSIS WITH COMPOSITE SUPERSTRUCTURE

(71) Applicant: Polaris Industries Inc., Medina, MN (US)

(72) Inventors: David W. Christian, Saint Francis, MN (US); Timothy W. Stenlund, Minneapolis, MN (US); Troy A. Pierce, Roseau, MN (US); Jeffrey A. Eaton, Roseau, MN (US); Matthew J. Prusak, Salol, MN (US)

(21) Appl. No.: 19/046,569

(22) Filed: Feb. 6, 2025

Related U.S. Application Data
(60) Provisional application No. 63/551,754, filed on Feb. 9, 2024.

(51) Int. Cl. B62M 27/02

(52) U.S. Cl. CPC B62M 27/02; B62M 2027/028

(57) ABSTRACT

A composite superstructure of a straddle-type vehicle, such as a snowmobile, formed from a fiber reinforced polymer and extending from a forward section coupled to a forward portion of a chassis of the vehicle to a rearward section coupled to a rearward portion of the chassis, where the superstructure defines at least one steering post mount configured to couple with a portion of a steering assembly of the vehicle.

### CROSS-REFERENCE TO RELATED APPLICATIONS

This application claims the benefit of U.S. Provisional Patent Application No. 63/551,754, filed Feb. 9, 2024, entitled “STRADDLE VEHICLE CHASSIS WITH COMPOSITE SUPERSTRUCTURE”, the entire contents of which are expressly incorporated by reference herein.

### BACKGROUND

Straddle-type recreational vehicles include a straddle seat configured such that an operator is seated stride the seat with feet on respective foot rests, footwells, or floorboards during operation of the vehicle. Such vehicles include a steering system, such as handle bars or a steering wheel, and operator controls at or near one or more of the steering system, foot rests, or a counsel or pod. Commonly, straddle-type vehicles include frame members extending from a position forward of the steering system toward an aft portion of the vehicle. The aft portion of certain straddle-type vehicles may define a tunnel extending from the operator area to the aft end of the vehicle. The frame members may support the straddle seat as well as one or more power plants (e.g., one or more combustion, electric, or hybrid motors and associated fuel tanks or battery packs).

### SUMMARY

The present disclosure describes straddle-type recreational vehicles, including, but not limited to, snowmobiles, all-terrain vehicles, personal watercraft, and two- or three-wheeled motorcycles, having one or more composite frame assemblies extending from a position forward of a steering system of the vehicle and either defining or coupled to frame members supporting at least one of an operator area, straddle seat of the vehicle, fuel tank, or tunnel. The described composite frame members facilitate manufacturing of the vehicle by reducing part count, assembly steps, assembly time, or combinations thereof. Additionally, compared to other frame members configurations, the described composite frame assemblies may reduce the total weight of the vehicle, reduce weight over the center of gravity of the vehicle, and stiffen the complete vehicle structure thereby providing for improved performance, handling, or both.

In some examples, the disclosure describes a superstructure of a straddle-type vehicle that includes a fiber reinforced polymer extending from a forward section coupled to a forward portion of a chassis of the vehicle to a rearward section coupled to a rearward portion of the chassis. The superstructure defines at least one steering mount aperture configured to receive therethrough and couple with a portion of a steering assembly of the vehicle.

In some examples, the disclosure describes a straddle-type vehicle that includes a chassis having a plurality of frame members configured to support a power plant, a suspension system, and an operator area. The vehicle also includes at least one front ground engaging member coupled by a respective front suspension of the suspension system to a forward portion of the chassis and at least one rear ground engaging member coupled by a respective rear suspension of the suspension system to a rearward portion of the chassis. The vehicle also includes a superstructure extending from a forward section coupled to the forward portion of the chassis to a rearward section coupled to the rearward portion of the chassis. The superstructure includes a fiber reinforced thermoplastic composite material.

In some examples, the disclosure describes a method of forming a composite superstructure of a straddle-type vehicle, the superstructure including a fiber reinforced polymer extending from a forward section coupled to a forward portion of a chassis of the vehicle to a rearward section coupled to a rearward portion of the chassis and the superstructure defining at least one steering mount aperture configured to receive therethrough and couple with a portion of a steering assembly of the vehicle. The method includes providing a composite material including the fiber reinforced polymer. The method also includes forming the composite material to define at least a portion of the composite superstructure. The method may include assembling one or more portions of the composite superstructure to define the composite superstructure. The method also includes coupling the composite superstructure to at least a portion of a chassis of a vehicle.

### BRIEF DESCRIPTION OF THE DRAWINGS

The disclosure can be understood in consideration of the following detailed description of various embodiments in connection with the accompanying drawings.

FIGS. 1A through 1E are conceptual diagrams illustrating various views of an example straddle-type recreational vehicle 10.

FIGS. 2A through 2K are conceptual diagrams illustrating various views of an example chassis having a composite superstructure.

FIGS. 3A and 3B are conceptual diagrams illustrating various views of an example composite superstructure including a left frame and a right frame.

FIGS. 4A through 4H are conceptual diagrams illustrating various view of an example composite superstructure including a left frame, a right frame, and a fuel tank shell.

FIG. 5 is an example technique 500 of forming a composite superstructure.

### DETAILED DESCRIPTION

For purposes of promoting an understanding of the principles of the disclosure, reference will now be made to the embodiments illustrated in the drawings, and specific language will be used to describe the same. It will nonetheless be understood that no limitation of the scope of the disclosure is intended by the illustration and description of certain embodiments of the disclosure. In addition, any alterations and/or modifications of the illustrated and/or described embodiment(s) are contemplated as being within the scope of the present disclosure. Further, any other applications of the principles of the disclosure, as illustrated and/or described herein, as would normally occur to one skilled in the art to which the disclosure pertains, are contemplated as being within the scope of the present disclosure.

The described composite frame assemblies may include fiber reinforced polymers defining structural components. Various configurations of the structural components may be derived from full chassis topology optimization. The structural components may include optional hollow portions. In some examples, the composite frame assemblies may include two or three components which may include A-side surfaces, portions of a fuel tank shell, or both.

Compared to other designs, use of the described composite frame assemblies may reduce part-count which may include, for example, a part-count reduction from 20 or more components to two or three components, thereby reducing assembly steps, assembly time, or both. Also, the described composite frame assemblies may reduce the total weight of the vehicle, reduce weight over the center of gravity of a vehicle, or both, which may improve vehicle performance, handling, or both. Further, the described composite frame assemblies may provide a stiffer frame structure, provide a more efficient load path coupling the front suspension of the vehicle to a rear section of the chassis and/or fuel tank shell, or both compared to other frame configurations, which may further enhance vehicle performance, handling, or both. Additionally, the described composite frame assemblies optionally may provide two different steering system mounting locations, thereby enabling commonality of frame components for multiple vehicle configurations.

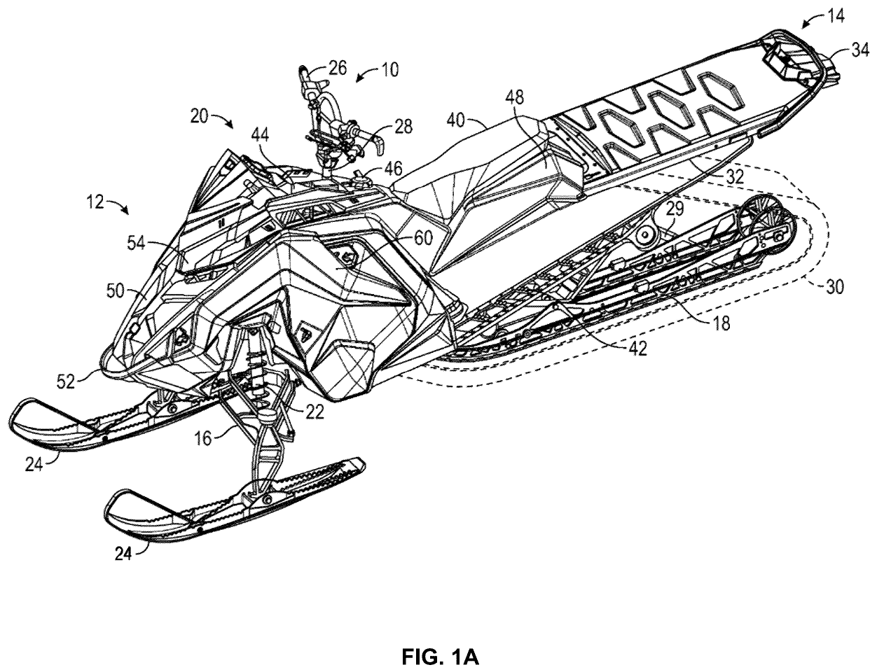

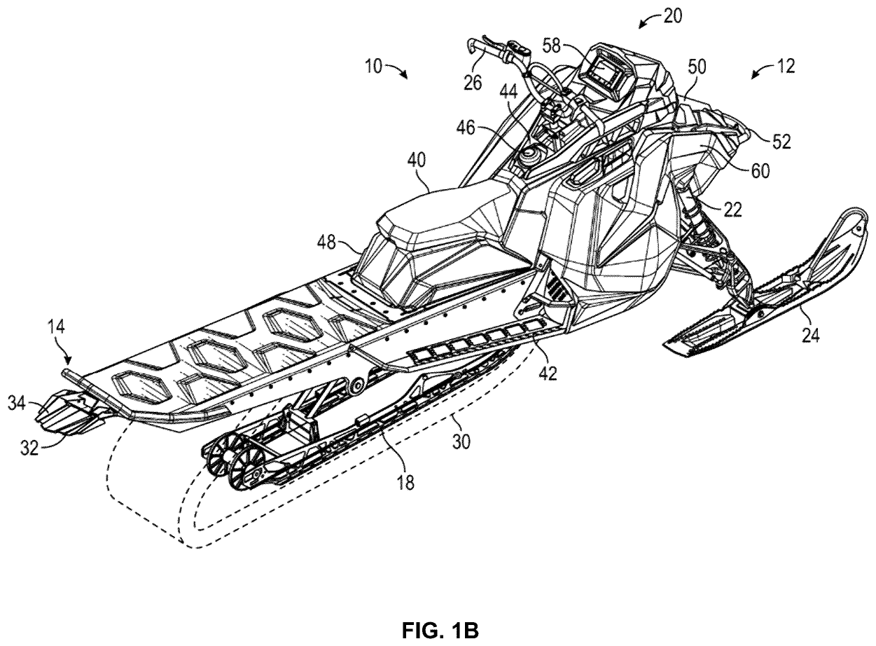

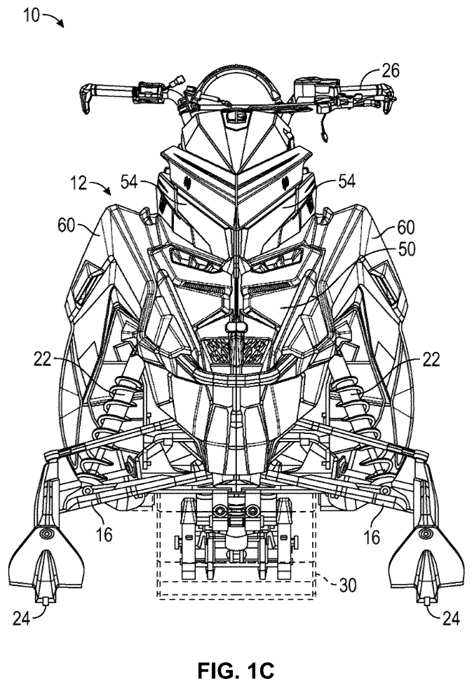

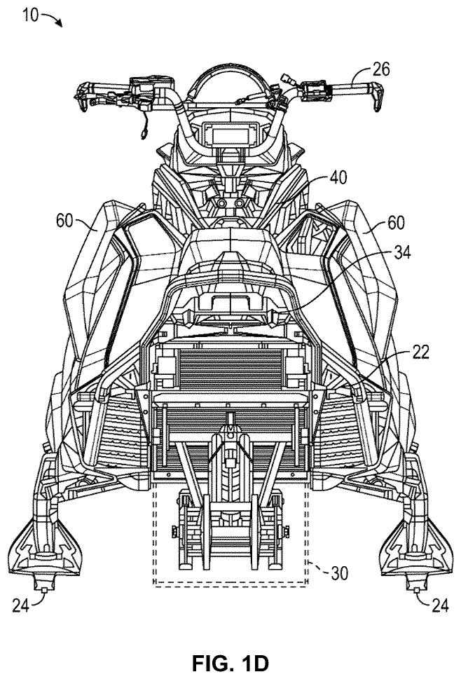

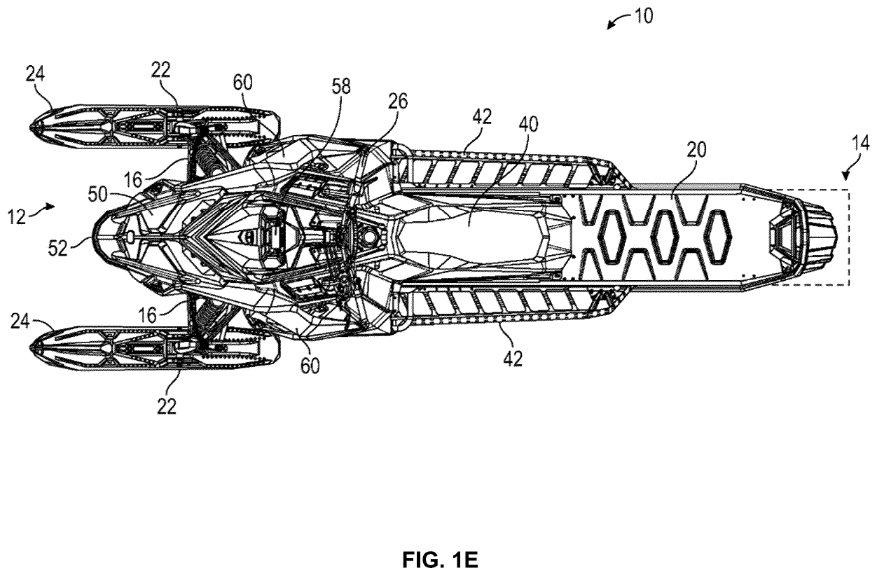

FIGS. 1A through 1E are conceptual diagrams illustrating various views of an example straddle-type recreational vehicle 10. Although illustrated as including a snowmobile, in other examples, vehicle 10 may include other straddle-type vehicles, including, but not limited to, snowmobiles, all-terrain vehicles, personal watercraft, and two- or three-wheeled motorcycles, or other vehicles having an operator area with a straddle seat. Vehicle 10 generally includes a front portion 12 and a rear portion 14. At the front portion 12 is a front suspension 16. At the rear portion 14 is a rear suspension 18. The front suspension 16 and the rear suspension 18 support a chassis 20.

Front suspension 16 includes shock absorbers 22, each of which is connected to a respective ski 24 and a forward portion of chassis 20. Although illustrated as including skis 24, in other examples, vehicle 10 may include other ground engaging members, such as, for example, wheels or endless-tracks. The shock absorbers 22 may be any damping devices suitable for absorbing shock resulting from the skis 24 passing over uneven terrain. The skis 24 are steered, at least in part, by a suitable steering assembly, such as handlebars 26 operatively coupled to skis 24.

Rear suspension 18 comprises a torque arm 29 coupling a rearward portion of chassis 20 to endless-track 30. Although illustrated as including endless track 30, in other examples, vehicle 10 may include other ground engaging members such as wheels or belts. Rotation of track 30 propels vehicle 10. Track 30 is circulated through a tunnel 32 defined at least in part by the rearward portion of chassis 20 and is positioned by the torque arm 29. Tunnel 32 may be tapered from a first height and/or a first width toward a smaller second height and/or a smaller second width the rear portion 14 of vehicle 10. In some examples, a flap 34 is mounted at the rear portion 14 and blocks debris, such as snow, dirt, or mud, from being kicked-up by the track 30.

Mounted to the chassis 20 and atop the tunnel 32 is a seat 40 for the operator of the vehicle 10. On both sides of the chassis 20 or tunnel 32 are running boards 42, upon which the operator may rest his or her feet when seated on the seat 40. The seat 40 is positioned to allow the driver to grasp the handlebars 26 for steering the vehicle 10. The handlebars 26 are mounted to a steering rod 28, which protrudes out from within the center console 44. At the center console 44 is a fuel cap 46 of a fuel tank 48.

At the front portion 12 of the vehicle 10 is a hood assembly 50, which is mounted on top of a nose pan or otherwise coupled to chassis 20. Hood assembly 50 may include a front bumper 52 protruding from a forward most end thereof. The hood assembly 50 houses headlights 54. An optional windshield is connected to an uppermost portion of the hood assembly 50. Associated with the hood assembly 50 is a display 58 viewable by the operator when seated on the seat 40. Mounted to opposite sides of the hood assembly are body panels 60, which are advantageously interchangeable.

Vehicle 10 includes a power plant, e.g., an engine assembly, configured to drive the track 30. The power plant may include any suitable engine, such as an electric motor, 2-stroke internal combustion engine, and 4-stroke internal combustion engine. The power plant may include a suitable exhaust assembly and oil tank assembly.

The vehicle 10 further includes a suitable control module. The control module may be arranged at any suitable location, such as within the hood assembly 50, beneath the center console 44, or within any suitable control mounted to the handlebars 26. The control module include processing circuitry, such as processor hardware (shared, dedicated, or group), that is configured to execute code and memory hardware (shared, dedicated, or group) that is configured to store code executed by the processor circuitry. The code is configured to provide the features of the control module described herein. The term memory hardware is a subset of the term computer-readable medium. The term computer-readable medium, as used herein, does not encompass transitory electrical or electromagnetic signals propagating through a medium (such as on a carrier wave). The term computer-readable medium is therefore considered tangible and non-transitory. Non-limiting examples of a non-transitory computer-readable medium are nonvolatile memory devices (such as a flash memory device, an erasable programmable read-only memory device, or a mask read-only memory device), volatile memory devices (such as a static random access memory device or a dynamic random access memory device), magnetic storage media (such as an analog or digital magnetic tape or a hard disk drive), and optical storage media (such as a CD, a DVD, or a Blu-ray Disc).

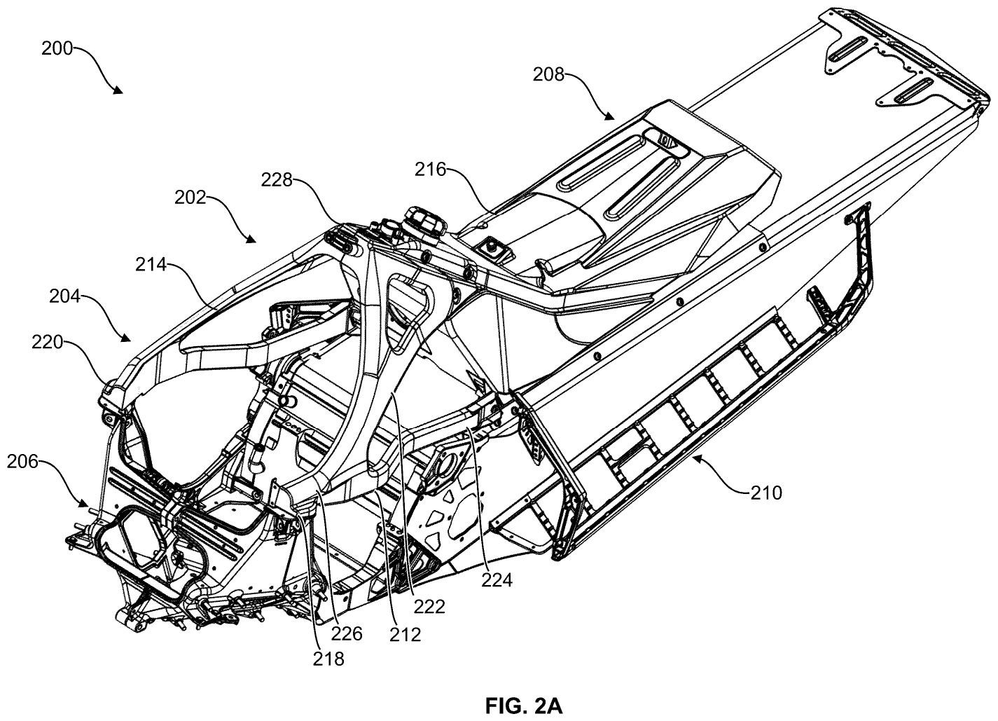

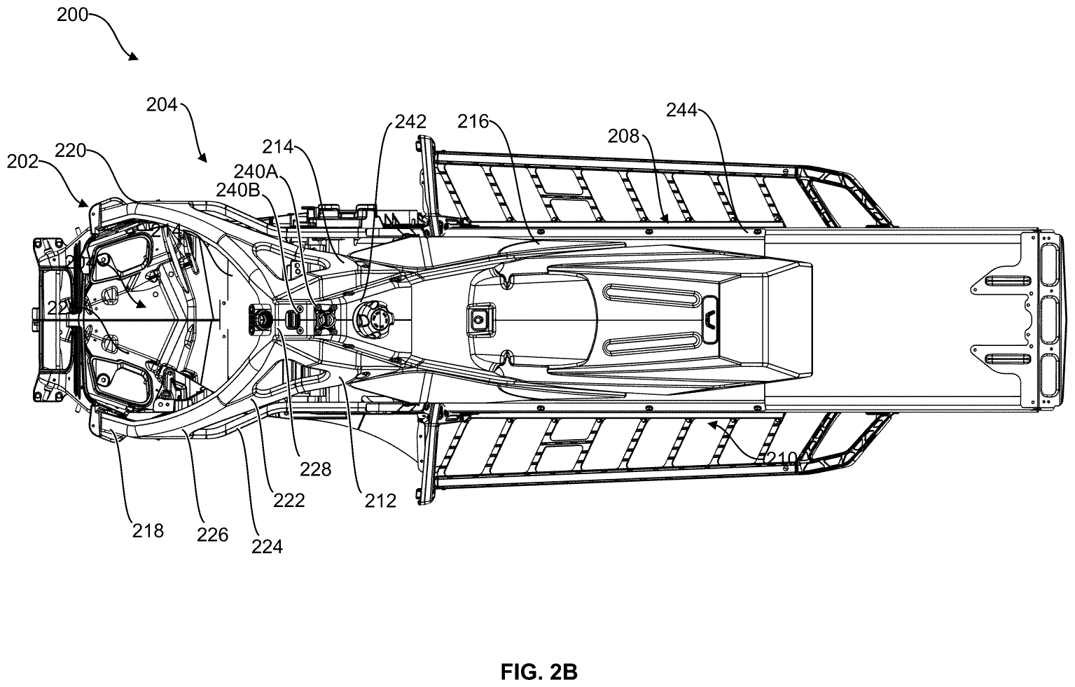

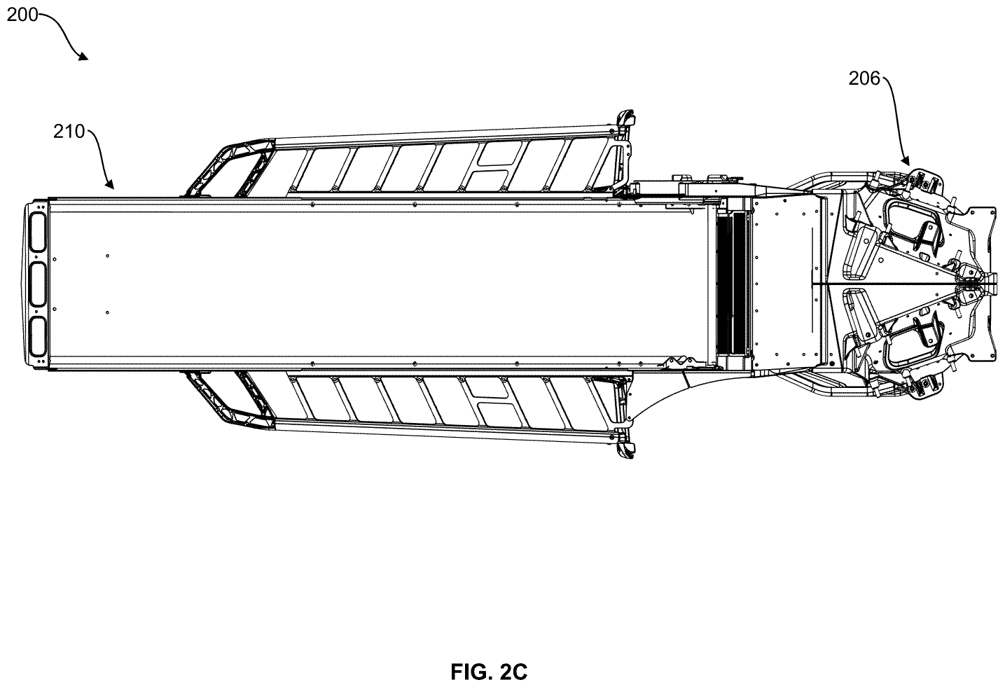

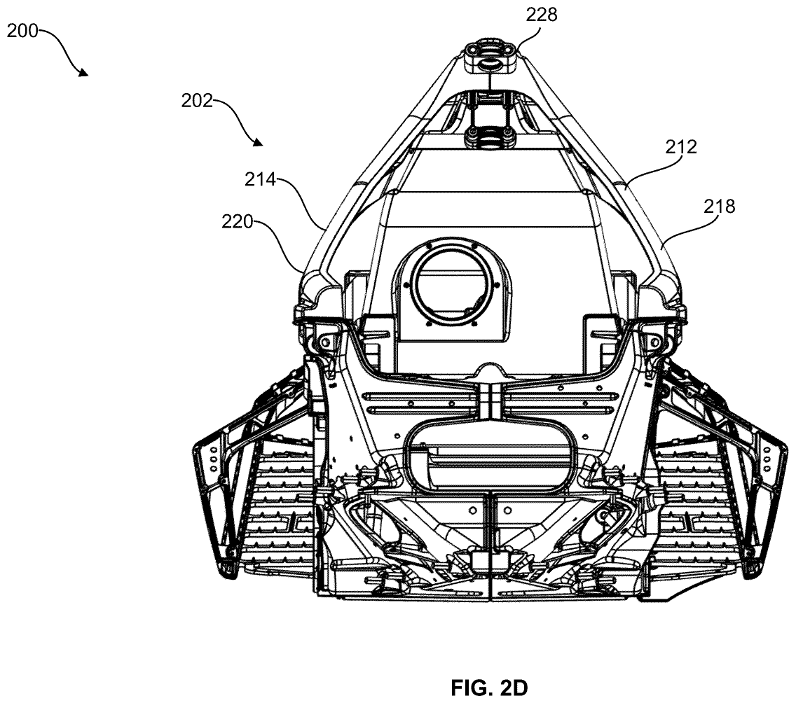

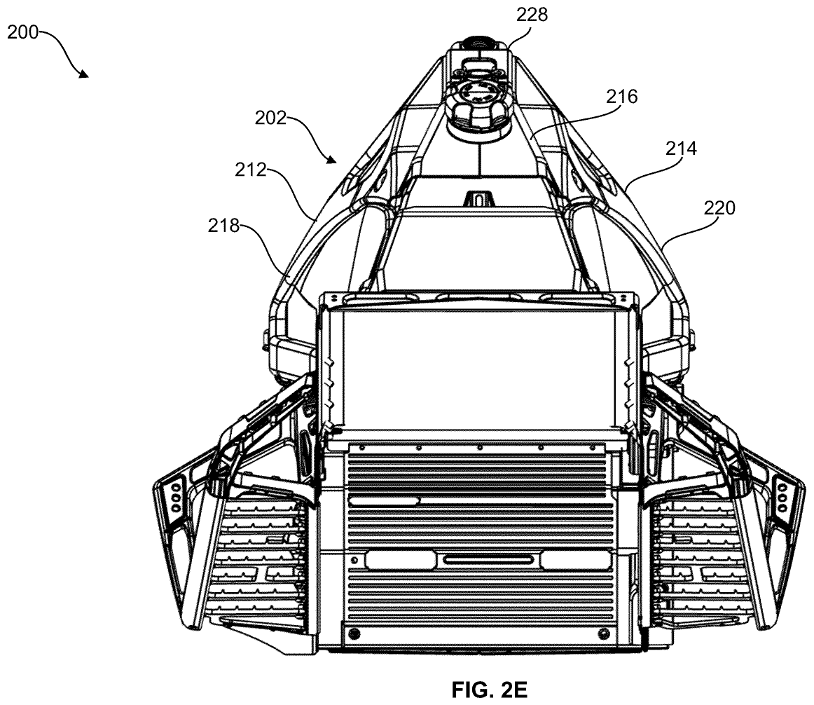

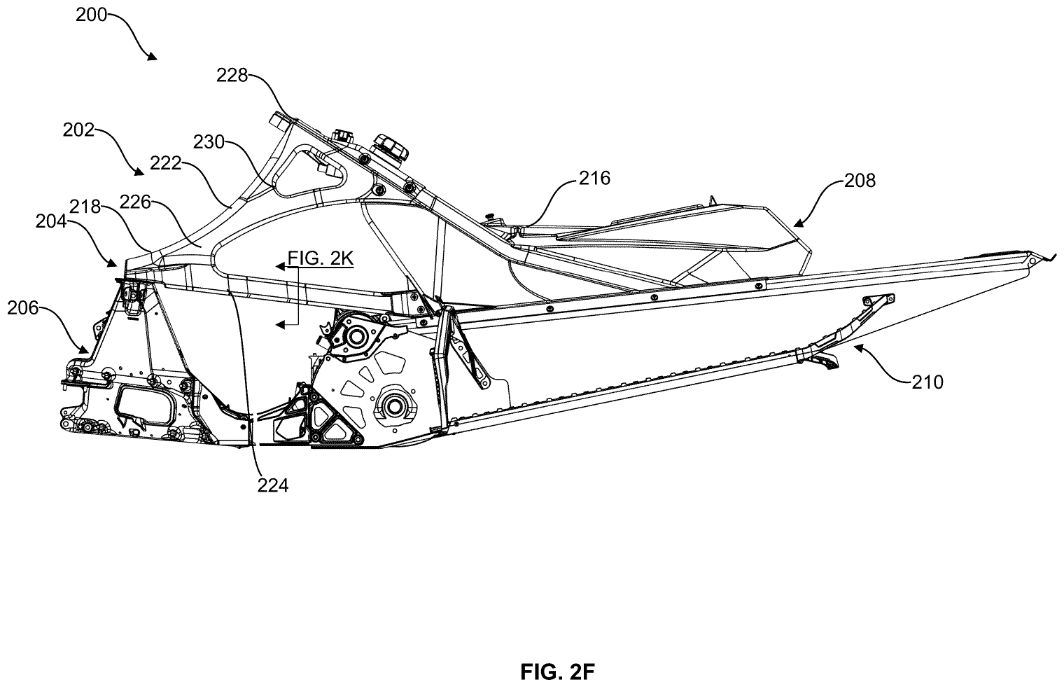

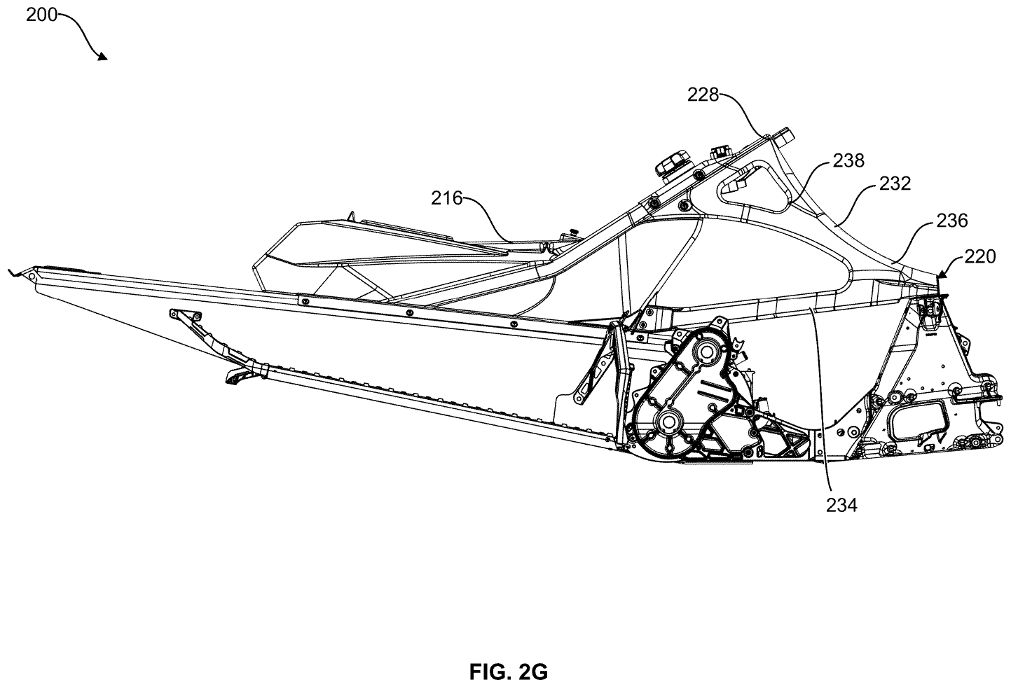

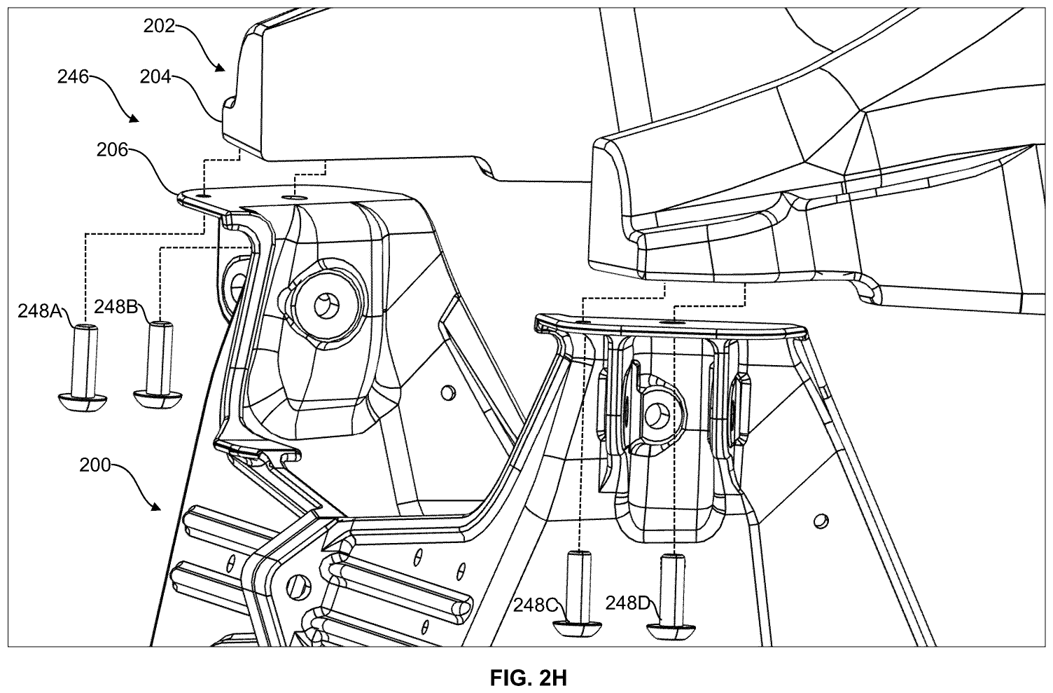

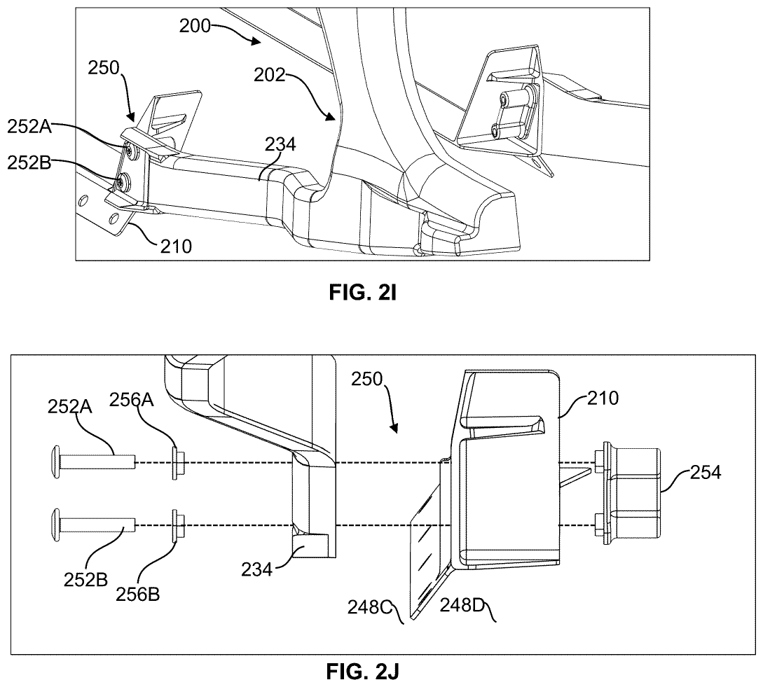

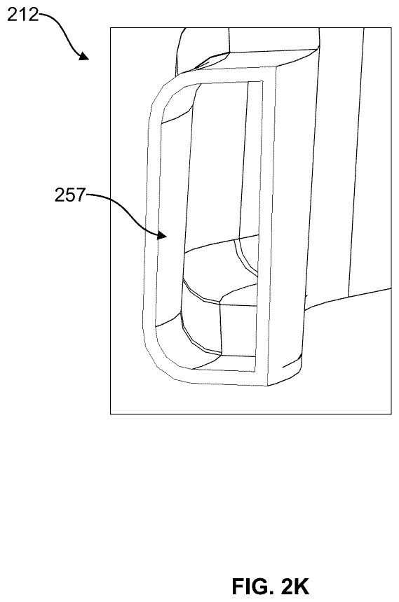

FIGS. 2A through 2K are conceptual diagrams illustrating various views of an example chassis 200 having a composite steering support structure 202, also referred to herein as a composite frame assembly. Composite superstructure 202 provides several benefits compared to other frame assemblies, such as metal frame assemblies or metal rear-steering-hoop-frame assemblies, defining the same or similar structures of chassis 200. For example, composite superstructure 202 may include fewer parts, which may reduce assembly steps and/or assembly time. Also, composite superstructure 202 may reduce the total weight of the vehicle, reduce weight over the center of gravity of a vehicle, or both, which may improve vehicle performance, handling, or both. Further, composite superstructure 202 may provide a stiffer frame structure, provide a more efficient load paths coupling the front suspension of the vehicle to a rear section of the chassis and/or fuel tank shell, or both, which may further enhance vehicle performance, handling, or both. Additionally, composite superstructure 202 optionally may provide two different steering system mounting locations, thereby enabling commonality of frame components for multiple vehicle steering system configurations. In these ways, and as further described below, composite superstructure 202 is configured to improve the manufacturability and overall performance of chassis 200, compared to other frame assembly designs.

Composite superstructure 202 extends from a forward section 204 coupled to a forward portion 206 of chassis 200 to a rearward section 208 coupled to a rearward portion 210 of chassis 200. Composite superstructure 202 may include a multi-piece assembly or unitary component. For example, composite superstructure 202 may include a left frame 212, a right frame 214, and a fuel tank shell 216. Each of left fame assembly 212, right frame assembly 214, and fuel tank shell 216 may include any suitable configuration that is configured to couple with select portions of chassis 200 and, optionally, support other components of a vehicle, such as suspension components, steering components, a power plant, operator interface components, a tunnel, or the like. Although described as including three components, in other examples, composite superstructure may include a unitary component, two components such as a left portion and a right portion or a front portion and a rear portion, or more than three components. As used herein, left, right, top, bottom, front, and back are used generally to describe portions of a vehicle or components thereof from the perspective of the operator when seated on the vehicle.

In some examples, the configuration of composite superstructure 202, including the number and shape of components, interfaces between components, or the like may be, at least in part, determined by or otherwise derived from topological optimization, such as full chassis topological optimization. Topology optimization, as understood by a person of ordinary skill, may use mathematical methods to optimize material layout within a given design space, for a given set of loads, boundary conditions, and constraints with the goal of improving the performance of a system. In some examples, topology optimization may use a finite element method (FEM) to evaluate the design performance. For example, a design may be optimized using either gradient-based mathematical programming techniques such as the optimality criteria algorithm and the method of moving asymptotes or non gradient-based algorithms such as genetic algorithms. By using topologic optimization, the above described design objective may be, at least partially, achieved. In some examples, designs produced via topological optimization may be further refined to facilitate manufacturability or provide other desired design qualities such as aesthetics. In some examples, symmetry of select feature was used for full chassis optimization.

Forward section 204 of composite superstructure 202 may include a first arm 218 and a second arm 220 defining a U-shape when viewed from the top of composite superstructure 202 (FIG. 2B). In some examples, first arm 218 may be a component of left frame 212 and second arm 220 may be a component of right frame 214. The base (e.g., vertex) of the U-shape may define the at least one steering post mount or aperture, discussed in further detail below. The U-shape of forward section 204 may improve load transfer, such as forces applied to chassis 200 and/or composite superstructure 202 from a suspension, from first arm 218 to second arm 220 compared to other shapes. The improved load transfer may result in a stiffer chassis, thereby improving handling compared to less stiff frame configurations. Although described as a U-shape, in other examples, forward section 204 may define other shapes, such as a V-shape or a substantially squared U-shape, may include crossbars or other supports extending between portions of the arms, or combinations thereof.

Additionally, or alternatively, each respective arm of first arm 218 and second arm 220 may define a wishbone shape when viewed, respectively, from left-side (FIG. 2F) or the right-side (FIG. 2G). For example, first arm 218 defines a wishbone-shape having a first leg 222 and a second leg 224, each leg extending from a vertex 226. Vertex 226 may be configured to couple to at least a portion of chassis 200 or a frame member coupled thereto. In some examples, at least a portion of vertex 226 may be coupled to at least a portion of a suspension system, such as a front suspension. First leg 222 of the wishbone-shaped first arm 218 extends from a first end at vertex 226 upward toward an apex 228 of composite superstructure 202. A second end of first leg 222, terminating at or near apex 228, may include a fork 230 defining a triangular aperture beneath apex 228. Fork 230 may be configured to more evenly distribute a load applied through first leg 222 across a greater area of composite superstructure 202, including but not limited to fuel tank shell 216, at or near apex 228 compared to a configuration without fork 230. Second leg 224 of the wishbone-shaped first arm 218 extends from a first end at vertex 226 rearward toward rearward portion 210 of chassis 200. Although not illustrated as including a fork, in other examples, second leg 224 may include a fork. Additionally, or alternatively, first leg 222 and second leg 224 may include more than one fork or other crossbar members configured to distribute load from first arm 218 to selected portions of chassis 200 or other components of the vehicle.

Similarly, as illustrated in FIG. 2G, second arm 220 defines a wishbone-shape having a first leg 232 having a fork 238 and a second leg 234, each leg extending from a vertex 236. First leg 232, second leg 234, vertex 236, and fork 238 may be the same as or substantially similar to first leg 222, second leg 224, vertex 226, and fork 230 described above in reference to first arm 218 as illustrated in FIG. 2F.

Composite superstructure 202 also may include fuel tank shell 216. Fuel tank shell 216 includes a separate component configured to couple to left frame 212, right frame 214, or both. In other examples, fuel tank shell 216 may include a left portion and a right portion, each portion coupled to or defining a unitary structure with left frame 212 and right frame 214, respectively. Although illustrated as including fuel tank shell 216, on other examples, composite superstructure 202 may include only left frame 212 and right frame 214, which may optionally extend toward and be configured to couple to at least a portion of rearward portion 210 of chassis 200.

A forward portion 242 of fuel tank shell 216 is coupled to, or defines at least a portion of, at least one steering post mount, such as steering post mounts 240A and 240B. By defining steering post mounts 240A and 240B composite superstructure 202 may provide greater vehicle handlebar position configurability during manufacturing, by owners, or both. For example, providing for multiple steering post mounts 240A and 240B allows for different steering post angles to be paired with a single part.

A rearward portion 244 of fuel tank shell 216 is configured to couple to rearward portion 210 of chassis 200. The coupling may include, for example, mechanical fasteners, adhesives, or combinations thereof. Additionally, forward portion 242 of fuel tank shell 216 may be coupled directly or indirectly to one or more portions of a front suspension. In this way, forward portion 242 of fuel tank shell 216 may be configured to simultaneously transmit front suspension loads to both rearward portions 210 of chassis 200, such as a tunnel assembly, and fuel tank shell 216.

Fuel tank shell 216 may be configured to support a separate fuel tank or define a fuel tank having cavity configured to retain a fuel. Fuel tank shell 216 may be configured to retain a fuel for an internal combustion engine. Example fuels may include, but are not limited to, petroleum-based fuels, gasoline, and alcohols. For example, fuel tank shell 216 may include a polymer, such as a fluorinated polymer, configured to direct contact with a liquid fuel or be configured to retain a rigid structure or bladder configured to retain a liquid fuel.

When supporting a separate fuel tank, fuel tank shell 216 may completely encapsulate the separate fuel tank or support at least a portion of the separate fuel tank. For example, a blow and/or rotomolded fuel tank meeting U.S. Environmental Protection Agency (EPA) fuel tank compliance standards, such as a fuel tank with a permeation resistant ethylene vinyl alcohol copolymer (EVOH) layer, may be co-molded with a pre-formed thermoplastic based structural reinforcements defining fuel tank shell 216. Example EPA standards may include but are not limited to 40 CFR Part 1051 and related EPA guidance letters CCD-05-14 & CISD-07-02. In some examples, the structural reinforcements defining fuel tank shell 216 may include solid surfaces completely or at least partially encapsulating the EPA compliant fuel tank, or at least one support member or a web of support members. In this way, an existing fuel tank design may be integrated with fuel tank shell 216 to define a structural frame member as a component of composite superstructure 202.

When defining a fuel tank having cavity configured to retain a fuel, fuel tank shell 216 may include a high specific modulus (GPa/(kg/m³)) and a high specific strength (MPa/(kg/m³)) material (e.g., a specific modulus within a range from about 0.9 to about 1.25 and a specific strength greater than about 1) having a shape selected to provide a high stiffness or inertia geometry and define the cavity configured to retain the fuel. In some examples, the high specific strength material, or at least a portion thereof defining a layer directly adjacent the cavity, may include a fluorinated polymer meeting EPA fuel tank compliance standards. Additionally, or alternatively, an EPA compliant bladder may be disposed within the cavity defined by fuel tank shell 216. In these ways, fuel tank shell 216 defines both an EPA compliant a fuel tank design and a structural frame member as a component of composite superstructure 202.

Although described as retaining a fuel, in other examples, such as examples in which chassis 200 is configured to support an electric motor or fuel tank in a different location, fuel tank shell 216 may define a storage area or other structure. By defining at least a portion of fuel tank shell 216, composition superstructure 202 may replace components of other designs, such as replace rear-steering-hoop-frame assemblies connecting an upper steering post mount to a tunnel or a rear chassis section.

Additionally, a footprint defined by fuel tank shell 216 may enable a geometry of composite superstructure 202 that projects rearward over a significant portion of a tunnel or other section of rearward portion 210 of chassis 200 with a more efficient load path compared to other designs such as rear-steering-hoop-frame assemblies. For example, an angle (relative to a plane parallel to ground) at which the portion of composite superstructure 202 defining fuel tank shell 216 intersects a tunnel or sections of rearward portion 210 of chassis 200 may be less than the angle at which a rear-steering-hoop-frame assembly intersects a tunnel or other sections of a rearward portion of a chassis.

In some examples, composite superstructure 202, such as at least one of left frame 212, right frame 214, and fuel tank shell 216 may include or otherwise define A-side surfaces including but not limited to console body work, side panel body work, and operator seat body work. The portion of composite superstructure 202 defining A-side body work may define exoskeleton body work construction configured to aesthetically highlight A-side structure and, optionally, reduce A-side body panel footprint (e.g., total area or size) and further enhance lightweighting of the vehicle. In this way, composite superstructure 202 may replace all or at least a portion of body panels used in other vehicle designs, thereby reducing tooling and manufacturing costs associated with fabrication of console body panels.

Composite superstructure 202 is formed, at least in part, from one or more composite materials such as fiber reinforced polymers (e.g., fiber reinforced polymeric materials). The fiber reinforced polymers include at least one of a thermoplastic or thermoset polymer and at least one of a plurality of reinforcing fibers. Example thermoplastics may include, but are not limited to, at least one of high-density polyethylene (HDPE), polypropylene (PP), acrylic, polycarbonate (PC), polyphenylene sulfide (PPS), acrylonitrile butadiene styrene (ABS), nylon (PA), and polyether ether ketone (PEEK). Example thermoset plastics may include, but are not limited to, epoxies, cyanate esters, vinyl esters, polyester polyimide, phenols, and bismaleimide. The plurality of reinforcing fibers may include, but is not limited to, at least one of aramid fibers, carbon fibers, and glass fibers. In some examples, the fiber reinforced polymer may include one or more additives, such as, for example, flame, smoke, and toxicity (FST) and chemical resistance (e.g., moisture or solvent) additives.

In some examples, additional materials may be integrated with the one or more composite materials of composite superstructure 202. For example, metal-based or non-metal reinforcement features may be integrated with select portion of composite superstructure 202. Reinforcement features may include, for example, additional material layers, brackets, washers, plates, or other structures configured to enhance a material performance (e.g., stiffness, tensile strength, or the like) at a selected region, such as regions that may experience high force loadings or other stresses or at interfaces of composite superstructure with chassis 200 or other vehicles components. Example metals of a metal-based reinforcement features may include, but are not limited to, steel, iron alloys, titanium, titanium alloys, aluminum, aluminum alloys, magnesium, magnesium alloys, molybdenum, molybdenum alloys, or combinations thereof. Example non-metals of a non-metal reinforcement features may include, but are not limited to, thermoplastics, thermoset plastics, ceramics, synthetic fibers, or combinations thereof. In some examples, reinforcement features may be integrated into the polymeric matrix and/or fibers of the composited material such as by mechanical interlocking or other mechanical fixation methods such as fasteners, adhesives, or the like.

As discussed above, forward section 204 is coupled to forward portion 206 of chassis 200 and rearward section 208 is coupled to rearward portion 210 of chassis 200. FIG. 2H is a conceptual diagram illustrating a partially exploded view of a joint 246 of forward section 204 of composite superstructure 202 and forward portion 206 of chassis 200. As illustrated in FIG. 2H, forward section 204 is coupled to forward portion 206 with fasteners 248A, 248B, 248C, and 248D (collectively, fasteners 248). Fasteners 248 may include bolts, rivets, self-tapping screws, or other devices configured to secure, and optionally draw towards one another, two components. In some examples, fasteners 248 may include bolts receivable by nuts or threaded metal-based or non-metal reinforcement features embedded in forward section 204. Additionally, or alternatively, forward section 204 may be adhesively bonded to forward portion 206 at joint 246.

FIG. 2I is a conceptual diagram illustrating a joint 250 defined by a portion of second leg 234 coupled to respective portions of rearward portion 210 of chassis 200. FIG. 2J is a conceptual diagram illustrating a partially exploded view of joint 250. As illustrated in FIGS. 2I and 2J, second leg 234 is coupled to rearward portion 210 with fasteners 252A and 252B (collectively, fasteners 252). Fasteners 252 may be the same as or substantially similar to fasteners 248 describe above in reference to FIG. 2H. In some examples, fasteners 252 may include bolts receivable by nuts, threaded features defined by rearward portion 210, or a retainer 254. In some examples, washers 256A and 256B (collectively, washers 256) may more evenly distribute loads or other stresses applied to second leg 234 through fasteners 252. Although illustrated as a separate components, in some examples, washers 256 may include a reinforcement feature embedded in or otherwise defined by at least a portion of second leg 234. Additionally, or alternatively, second leg 234 may be adhesively bonded to rearward portion 210 at joint 250.

As illustrated in the cross-sectional view of left frame 212 in FIG. 2K, in some examples, at least a portion of the fiber reinforced polymer of composite superstructure 202 may include a tubular member defining a hollow core 257. The advantage to hollow construction is the ability to increase cross-sectional inertia/stiffness with highly efficient use/consumption of material. The result is stiff and lightweight parts in comparison to their solid/filled counterparts. Additionally, or alternatively, hollow core portions may be configured to damp the transmission of vibrations from select portions of a vehicle.

Hollow core 257 may be formed by any suitable method. For example, at least portions of composite superstructure 202 including hollow core portions may be formed at two separate clamshell components that are subsequently coupled to define hollow core 257. Coupling the clamshell components may be accomplished via adhesive bonding or polymer welding techniques to define a unitary tubular member. Other methods of forming hollow core portion may include lost core molding, semi-permanent core molding, gas-assisted molding, overmolding, bladder molding, or the like.

A material that is less dense than a material of composite superstructure 202 may be disposed within at least a portion of hollow core 257. For example, the less dense material may include at least one of a gas, a foam, an elastomeric material, or a polymeric material. The less dense material may be configured to provide at least some structural continuity or noise, vibration, and harshness (NVH) damping compared to a hollow core composite superstructure 202 without the less dense material or a solid core material. In these ways, portion of composite super structure 202 including one or more hollow core 257 may be lighter than comparable solid components and reduce NVH compared to comparable solid components.

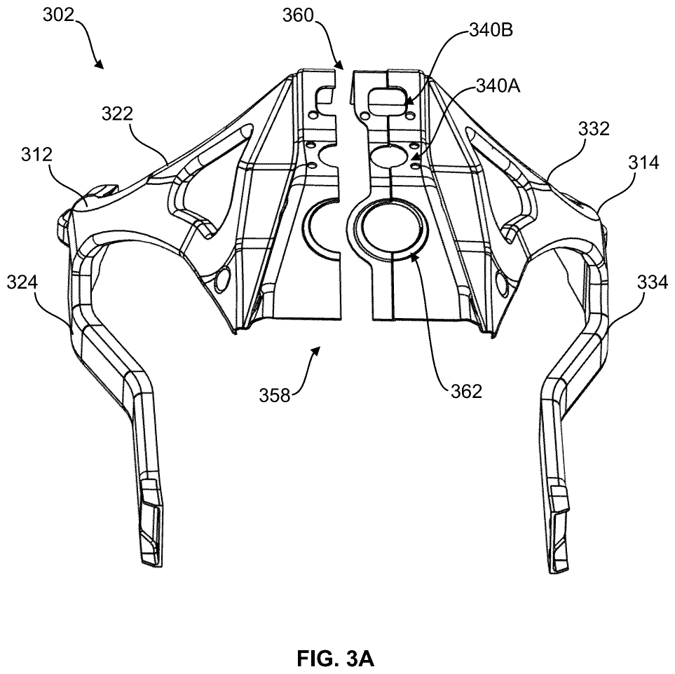

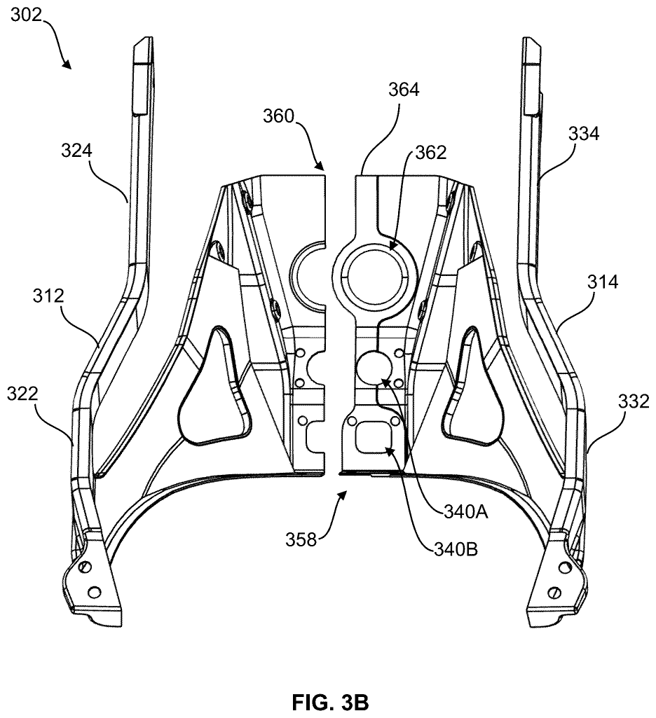

FIGS. 3A and 3B are conceptual diagrams illustrating various views of an example composite superstructure 302 including a left frame 312 and a right frame 314. Composite superstructure 302 may be the same as or substantially similar to composite super structure 202 described above in reference to FIGS. 2A through 2J, except for the differences described herein. For example, left frame 312 and right frame 314, each may define a wish-bone shape having first legs 322 and 332 and second legs 324 and 334.

Each of first legs 322 and 332 may define a portion of a console region 358 and terminate at an interface region 360. Console region 358 defines steering post mounts 340A and 340B. Optionally, console region 358 may define a fuel fill aperture 362. Fuel fill aperture 362 may be configured to fluidly couple to a fuel tank, receive therein a fuel cap, or both.

Interface region 360 includes portions of left frame 312 and right frame 314 that are configured to couple to one another. For example, as illustrated in FIG. 3A, right frame 314 may include a stepped-down portion 364 that is configured to receive a corresponding portion of left frame 312. Stepped-down portion 364 may enable an A-side surface (i.e., top surface) of left frame 312 and right frame 314 to be substantially planar (i.e., flush) when the corresponding portion of left frame 312 overlaps stepped-down portion 364 of right frame 314. During assembly, left frame 312 may be adhesively bonded to right frame 314 along interface region 360. Additionally, or alternatively, left frame 312 may be coupled to right frame 314 using suitable fasteners or other technique such a polymer welding or the like. In examples in which left frame 312 is welded to right frame 314, interface region 360 may define a substantially unitary composite superstructure 302. That is, at least a portion of a thermoplastic matrix of left frame 312 may be integrated with at least a portion of a thermoplastic matrix of right frame 314, thereby forming a single unitary component.

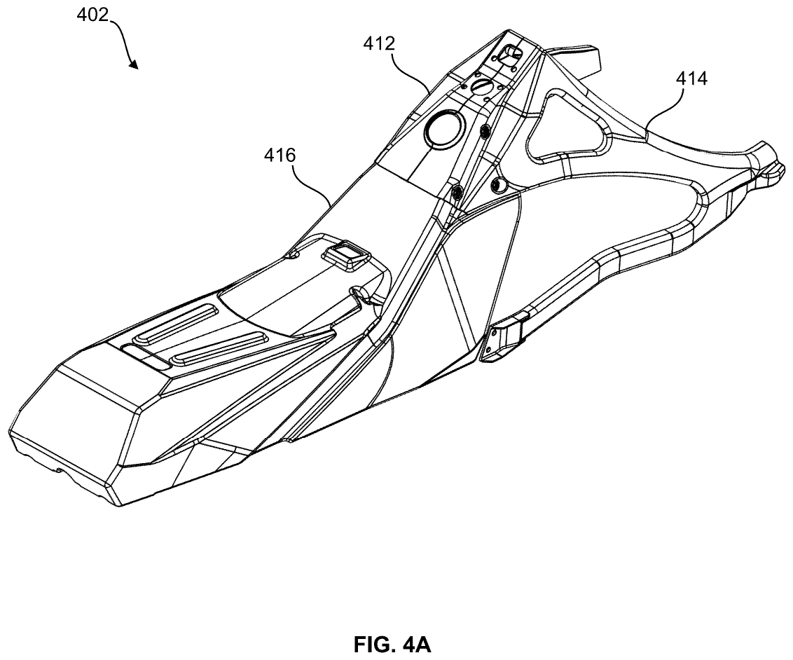

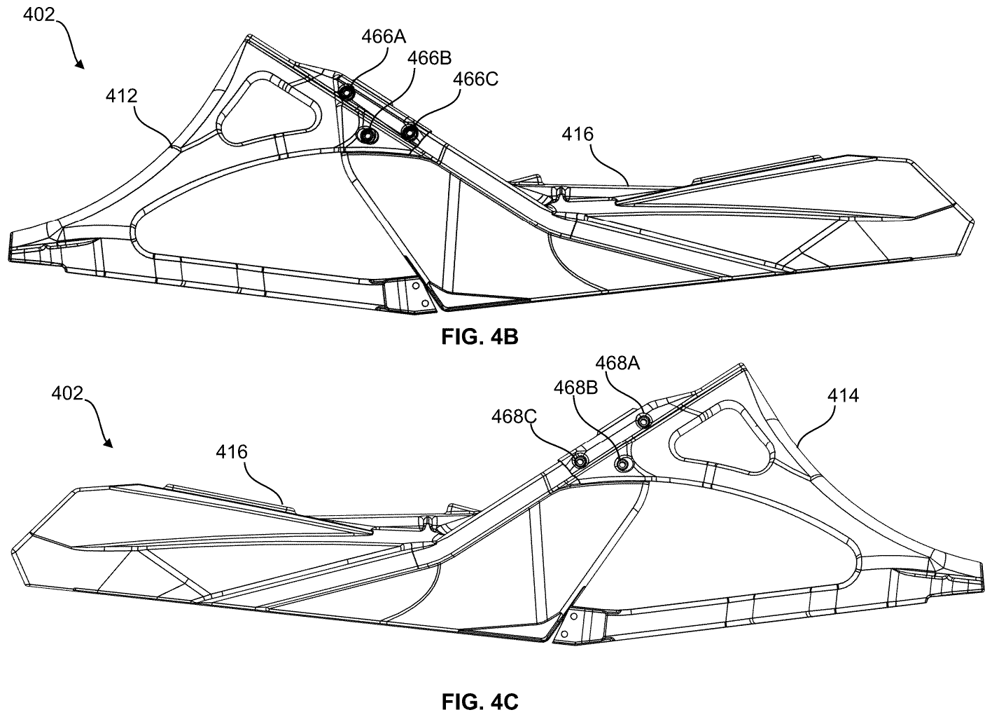

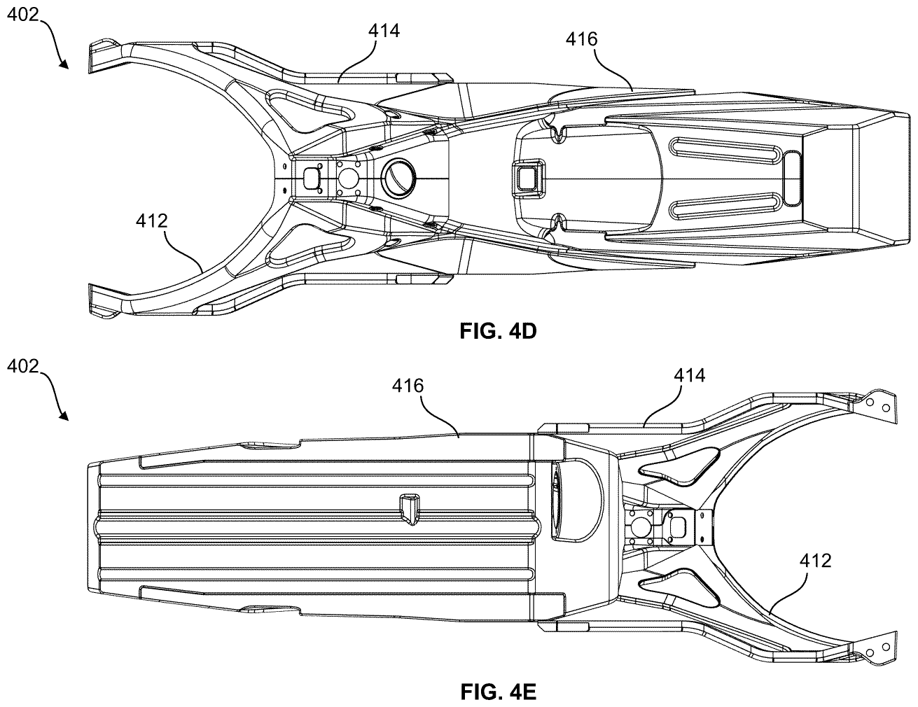

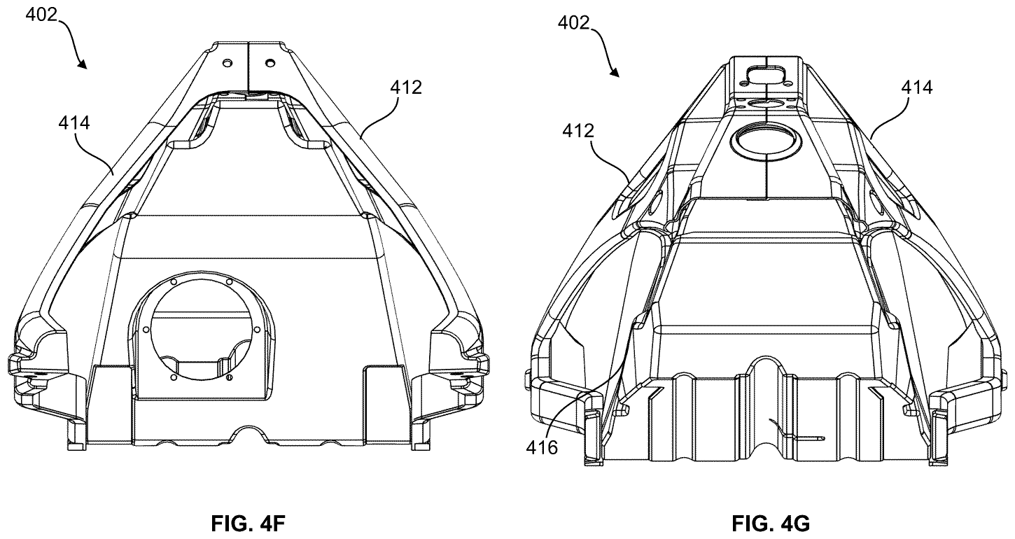

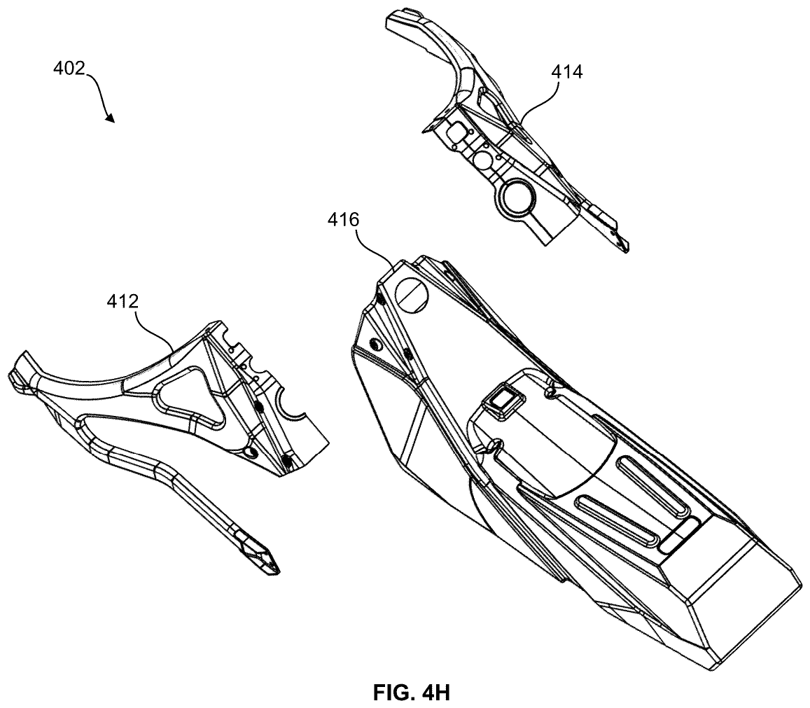

FIGS. 4A through 4H are conceptual diagrams illustrating various view of an example composite superstructure 402 including a left frame 412, a right frame 414, and a fuel tank shell 416. Composite superstructure 402 may be the same as or substantially similar to composite super structure 202, composite super structure 302, or both, as described above in reference to FIGS. 2A through 3B, except for the differences described herein.

Each of left frame 412 and right frame 414 are configured to couple to fuel tank shell 416. For example, left frame 412 may be coupled to fuel tank shell 416 with fasteners 466A, 466B, and 466C (collectively, fasteners 466). Similarly, right frame 414 may be coupled to fuel tank shell 416 with fasteners 468A, 468B, and 468C (collectively, fasteners 468). Fasteners 466 and 468 may be the same as or substantially similar to fasteners 248 and/or 252 described above in reference to FIGS. 2H through 2J. For example, fasteners 466 and 468 may include bolts receivable by nut, threaded reinforcement features embedded in fuel tank shell 416, or a retainer (e.g., retainer 254). Additionally, or alternatively, left frame 412 and/or right frame 414 may be adhesively bonded to fuel tank shell 416. Additionally, or alternatively, left frame 412 and/or right frame 414 may be coupled to fuel tank shell 416 by polymer welding, thereby forming a single unitary component.

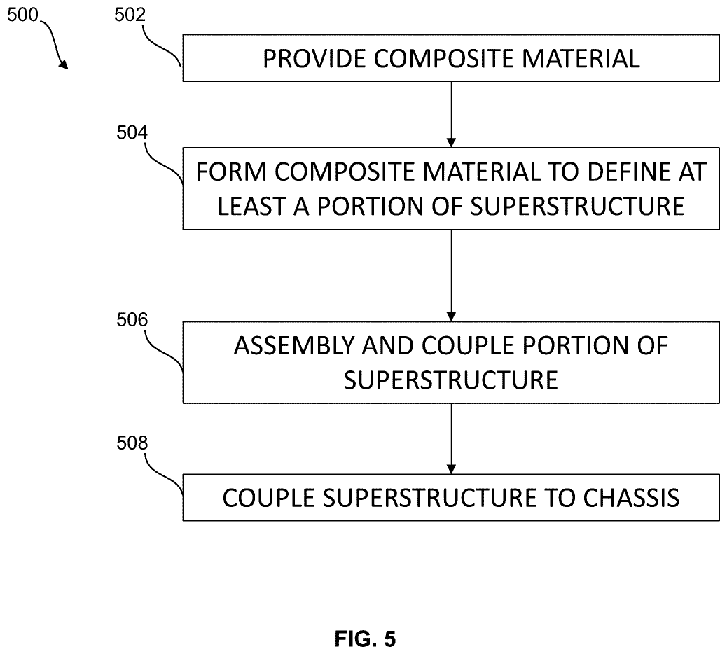

Composite superstructures 202, 302, and 402 may be formed using any suitable method. FIG. 5 is an example technique 500 of forming a composite superstructure. While technique 500 is described in reference to composite superstructure 202, the technique may be used to form other composite superstructures, including, but not limited to, composite superstructures 302 and 402. Also, composite superstructure 202 may be formed using different techniques.

Technique 500 includes providing a composite material (502). The composite material may include any composite materials described herein. In examples in which reinforcement features are used, the technique also may include providing reinforcement features. In some examples, providing the composite material may include layup of a component material, such as one or more layers or sheets of composite material in a form.

Technique 500 also includes forming the composite material to define at least a portion of composite superstructure 202 (504). For example, the technique may include independently forming each of left frame 212, right frame 214, and fuel tank shell 216. Additionally, or alternatively, the technique may include forming a first half and a second half of a clamshell defining at least a portion of composite superstructure 202. In some examples, forming the composite material may include trimming excess material from a formed component. Additionally, the technique may include determining, for example, by topology optimization, at least a portion of a configuration of the composite superstructure.

In some examples, forming the composite material may include forming at least a portion of a component to define a hollow core 257. Optionally, the technique may include forming the hollow core 257 around a material disposed in hollow core 257 or injecting a material into hollow core 257. Forming the hollow core portion 257 may include any suitable method of forming a hollow core, such as using one or more of the above-described techniques.

Technique 500 optionally includes assembling and coupling portions of composite superstructure 202 (506). For example, when composite superstructure 202 includes two or more component parts, the component parts may be coupled using fasteners, adhesives, plastic welding, compression molding, thermoforming, over-laying of additional composite material, or other methods of joining plastic components. In some examples, coupling portion of composite superstructure may include consolidating at least a portion of the thermoplastic matrix of two or more components. In examples in which components include clamshell components, assembling and coupling the components may include plastic welding a first half of the clamshell to a second half of the clamshell. The technique optionally may include finishing at least a portion of composite superstructure to provide a selected surface finish.

Technique 500 also includes coupling composite superstructure 202 to at least a portion of chassis 200 or other components of a vehicle (508). In some examples, coupling composite superstructure 202 may include coupling via one or more reinforcement features as described above.

While the disclosure has been described in connection with what is presently considered to be the most practical and preferred embodiments, it is to be understood that the disclosure is not to be limited to the disclosed embodiments, but on the contrary, is intended to cover various modifications and equivalent arrangements included within the spirit and scope of the appended claims, which scope is to be accorded the broadest interpretation so as to encompass all such modifications and equivalent structures as permitted under the law. Furthermore, it should be understood that while the use of the word preferable, preferably, or preferred in the description above indicates that feature so described may be more desirable, it nonetheless may not be necessary and any embodiment lacking the same may be contemplated as within the scope of the disclosure, that scope being defined by the claims that follow. In reading the claims it is intended that when words such as “a,” “an,” “at least one” and “at least a portion” are used, there is no intention to limit the claim to only one item unless specifically stated to the contrary in the claim. Further, when the language “at least a portion” and/or “a portion” is used the item may include a portion and/or the entire item unless specifically stated to the contrary.

What is claimed is:

1. A superstructure of a straddle-type vehicle comprising a fiber reinforced polymer extending from a forward section coupled to a forward portion of a chassis of the vehicle to a rearward section coupled to a rearward portion of the chassis, wherein the superstructure defines at least one steering mount aperture configured to receive therethrough and couple with a portion of a steering assembly of the vehicle.

2. The superstructure of claim 1, wherein the fiber reinforced polymer comprises:
a thermoplastic matrix comprising at least one of high-density polyethylene (HDPE), polypropylene (PP), acrylic, polycarbonate (PC), polyphenylene sulfide (PPS), acrylonitrile butadiene styrene (ABS), and polyether ether ketone (PEEK); and
a plurality of reinforcing fibers comprising at least one of aramid fibers, carbon fibers, and glass fibers.

3. The superstructure of claim 1, wherein at least a portion of the fiber reinforced polymer comprises a tubular member defining a hollow core, and wherein at least one of a gas, a foam, an elastomeric material, or a polymeric material is disposed within at least a portion of the hollow core.

4. The superstructure of claim 1, wherein the forward section of the superstructure comprises a first arm and a second arm defining a U-shape, when viewed from the top, the base of the U defining the at least one steering mount aperture.

5. The superstructure of claim 1, wherein the forward section of the superstructure comprises a first arm and a second arm, each respective arm defining a wishbone shape, when viewed from the side, wherein a first leg of the wishbone extends upward toward an apex of the superstructure and a second leg of the wishbone extends rearward, and wherein the first leg defines an aperture beneath the apex.

6. The superstructure of claim 1, wherein the forward section defines at least a first steering post mount and a second steering post mount.

7. The superstructure of claim 1, wherein rearward section of the superstructure defines fuel tank shell, wherein the forward section of the superstructure is configured to transmit forces from a suspension of the vehicle through the fuel tank shell to the rearward portion of the chassis.

8. The superstructure of claim 1, wherein fuel tank shell defines at least a portion of a fuel tank of the vehicle.

9. The superstructure of claim 1, wherein the forward section of the superstructure is configured to couple to a front suspension and wherein the rearward section of the superstructure is configured to support an operator seat.

10. The superstructure of claim 1, wherein the superstructure defines a left portion and a right portion configured to be couped along an interface defining at least a portion of a central console.

11. A straddle-type vehicle comprising:
a chassis comprising a plurality of frame members configured to support a power plant, a suspension system, and an operator area;
at least one front ground engaging member coupled by a respective front suspension of the suspension system to a forward portion of the chassis;
at least one rear ground engaging member coupled by a respective rear suspension of the suspension system to a rearward portion of the chassis;
a superstructure extending from a forward section coupled to the forward portion of the chassis to a rearward section coupled to the rearward portion of the chassis,
wherein the superstructure comprises a fiber reinforced thermoplastic composite material.

12. The straddle-type vehicle of claim 11, wherein the superstructure defines at least one steering mount aperture configured to receive therethrough and couple with a portion of a steering assembly of the vehicle.

13. The straddle-type vehicle of claim 11, wherein the straddle-type vehicle comprises a snowmobile.

14. The straddle-type vehicle of claim 11, wherein the powerplant comprises an internal combustion engine, wherein the vehicle further comprises a fuel tank configured to deliver a liquid fuel to the internal combustion engine, and wherein at least a portion of the rearward section of the superstructure defines at least a portion of the fuel tank or is coupled to at least a portion of the fuel tank.

15. The straddle-type vehicle of claim 11, wherein the at least one rear ground engaging member comprises an endless track, and wherein the rearward portion of the chassis comprises a tunnel extending over at least a portion of the endless track, and wherein at least a portion of the rearward section of the superstructure is coupled to the tunnel.

16. The straddle-type vehicle of claim 11, wherein the superstructure defines a first aperture configured to receive therethrough a portion of a steering assembly of the vehicle in a first position and a second aperture configured to receive therethrough the portion of the steering assembly of the vehicle in a second, different position, wherein at least a portion of the superstructure adjacent the aperture is configured to secure a mounting structure of the steering assembly.

17. A method of forming a superstructure of a straddle-type vehicle, the method comprising:
providing a composite material including a fiber reinforced polymer;
forming the composite material to define one or more portions of the superstructure;
assembling the one or more portions of the composite superstructure to define the composite superstructure, wherein the superstructure is configured to define at least one steering mount aperture configured to receive therethrough and couple with a portion of a steering assembly of the vehicle; and
coupling the composite superstructure to at least a portion of a chassis of a vehicle, wherein the superstructure extends from a forward section coupled to a forward portion of the chassis to a rearward section coupled to a rearward portion of the chassis.

18. The method of claim 17, wherein the fiber reinforced polymer comprises:
a thermoplastic matrix comprising at least one of high-density polyethylene (HDPE), polypropylene (PP), acrylic, polycarbonate (PC), polyphenylene sulfide (PPS), acrylonitrile butadiene styrene (ABS), and polyether ether ketone (PEEK); and
a plurality of reinforcing fibers comprising at least one of aramid fibers, carbon fibers, and glass fibers.

19. The method of claim 17, wherein the method further comprises:
consolidating at least a portion of a thermoplastic matrix of the composite material; and
trimming excess material from the formed composite material.

20. The method of claim 17, wherein forming the composite material comprises forming the composite material to define at least one hollow core portion of the superstructure.
